(19) United States
(12) Patent Application Publication
(10) Pub. No.: US 2025/0015471 A1
(43) Pub. Date: Jan. 9, 2025

(54) Bipolar Storage Battery

(71) Applicants: The Furukawa Battery Co., Ltd., Yokohama (JP); Furukawa Electric Co., Ltd., Tokyo (JP)

(72) Inventors: Kenji Hirota, Iwaki (JP); Yoshinobu Taira, Iwaki (JP)

(21) Appl. No.: 18/893,216

(22) Filed: Sep. 23, 2024

Related U.S. Application Data
(63) Continuation of application No. PCT/JP2023/007096, filed on Feb. 27, 2023.

(30) Foreign Application Priority Data
Mar. 24, 2022 (JP) 2022-048863

(51) Int. Cl. H01M 50/627; H01M 10/12; H01M 50/147

(52) U.S. Cl. CPC H01M 50/627; H01M 10/12; H01M 50/147

(57) ABSTRACT

The occurrence of a short circuit inside a cell member is prevented by means of a through hole formed to prevent an influence on components, such as deformation of a separator, inside a space housing the cell member caused by an injected electrolyte solution, while also considering ease of the injection. A battery includes cell members stacked and arranged with spacing, each including a positive electrode, a negative electrode, and a separator. The battery includes a space forming member, and a through hole open inside a space housing the cell member. The through hole includes an outer opening connected to an inner opening by a through path, and a wall portion in at least part of the through path. The wall portion makes an electrolyte solution have a different flow direction when flowing in from the outer opening compared to flowing from the inner opening into the space.

### CROSS-REFERENCE TO RELATED APPLICATION

This application is a continuation of PCT Application No. PCT/JP2023/007096, filed Feb. 27, 2023, the disclosure of which is incorporated herein in its entirety by reference.

### TECHNICAL FIELD

Embodiments of the present invention relate to a bipolar storage battery.

### BACKGROUND

These days, the number of power generation facilities utilizing natural energy such as sunlight and wind power is increasing. In such power generation facilities, because the amount of power generation is difficult to control, the power load is leveled by using a storage battery. That is, when the amount of power generation is larger than a consumption, a difference is charged into the storage battery, and when the amount of power generation is smaller than a consumption, a difference is discharged from the storage battery. As the storage battery described above, a lead-acid storage battery is frequently used for economic efficiency, safety, etc. As such a conventional lead-acid storage battery, for example, one described in JP H06-349519 A is known.

The lead-acid storage battery described in JP H06-349519 A includes bipolar plates in each of which a positive active material layer and a negative active material layer are provided on one face and the other face of a conductive metal base material. The bipolar plates are sandwiched between a pair of end plates, and a separator is provided between each pair of adjacent bipolar plates. The lead-acid storage battery used for power storage systems like those described above should be capable of withstanding long-term operation in view of its uses.

### SUMMARY

Here, the separator sandwiched between the positive active material layer and the negative active material layer facing each other is intended to contact the positive active material layer and the negative active material layer to bring an electrolyte solution impregnated in the separator into contact with the positive active material layer and the negative active material layer. Furthermore, the separator is also intended to be pressing the positive active material layer and the negative active material layer.

Accordingly, the separator is desirably in uniform contact with the positive active material layer and the negative active material layer. However, for example, when the electrolyte solution is injected at the time of assembly, the separator may be deformed by the pressure at the time of injecting the electrolyte solution. Uniform contact may be inhibited if the injection amount per unit time is increased to shorten the takt time of the assembly. When the separator is deformed as described above, it may cause not only the positive active material layer and the negative active material layer to not be brought into uniform contact with each other, but also a short circuit is likely to occur between a positive electrode side and a negative electrode side.

Further, in view of the roles of the separator described above, when the surface pressure applied to the positive active material layer and the negative active material layer by the separator is non-uniform due to the deformation of the separator, a holding force of both the active material layers decreases. A decrease in the holding force may cause a decrease in battery capacity due to peeling of the active material layers.

Furthermore, if a momentum of injection at the time of injecting the electrolyte solution is strong, it is not always possible that the injected electrolyte solution has no influence when contacting components of the storage battery other than the separator. It is considered that such a state leads to unexpected shortening of the life of the storage battery.

When the electrolyte solution is injected in this manner, it is necessary to weaken the momentum as described above. Meanwhile, a state where the electrolyte solution does not enter a space housing a cell member is also not preferable in relation to the takt time.

An object of the present invention is to provide a bipolar storage battery that can prevent the occurrence of a short circuit between a positive electrode side and a negative electrode side inside a cell member by means of a through hole formed and arranged to prevent an influence on components inside a space housing the cell member caused by the pressure of an electrolyte solution to be injected, such as deformation of a separator, when the electrolyte solution is injected into the space, while also considering ease of the injection.

A bipolar storage battery according to a first aspect of the present invention includes a plurality of cell members stacked with spacing. Each of the cell members includes a positive electrode including a positive electrode current collector and a positive active material layer, a negative electrode including a negative electrode current collector and a negative active material layer, and a separator interposed between the positive electrode and the negative electrode. The bipolar storage battery further includes a space forming member forming a plurality of spaces individually housing the plurality of cell members. The space forming member includes a substrate covering at least one of the positive electrode side or the negative electrode side of each of the cell members, and a frame surrounding a side face of each of the cell members. The bipolar storage battery further includes a through hole communicating with the space housing the cell member. The through hole has an outer opening open on an outer wall face of the space forming member and an inner opening open on an inner wall face of the space forming member, and a wall portion is provided in at least a part of a through path connecting the outer opening and the inner opening. The wall portion makes a first flow direction of an electrolyte solution flowing in from the outer opening different from a second flow direction in which the electrolyte solution flows out from the inner opening into the space.

A bipolar storage battery according to a second aspect of the present invention includes a plurality of cell members stacked with spacing. Each of the cell members includes a positive electrode including a positive electrode current collector and a positive active material layer, a negative electrode including a negative electrode current collector and a negative active material layer, and a separator interposed between the positive electrode and the negative electrode. The bipolar storage battery further includes a space forming member forming a plurality of spaces individually housing the plurality of cell members. The space forming member includes a substrate covering at least one of the positive electrode side or the negative electrode side of each of the cell members, and a frame surrounding a side face of each of the cell members. The bipolar storage battery further includes a through hole open inside the space housing the cell member. The through hole has an outer opening open on an outer wall face of the space forming member and an inner opening open on an inner wall face of the space forming member. An opening position of the outer opening of the through hole is above an opening position of the inner opening when a stacking direction of the cell members and the space forming member is parallel to a vertical direction.

When a configuration according to the first aspect or the second aspect is adopted, it is possible to prevent the occurrence of the short circuit between the positive electrode side and the negative electrode side inside the cell member using the through hole formed and arranged to prevent the influence on components inside the space housing the cell member caused by the pressure of the electrolyte solution, such as deformation of the separator, when the electrolyte solution is injected into the space, while also considering ease of the injection.

### BRIEF DESCRIPTION OF THE DRAWINGS

FIG. 1 is a cross-sectional view illustrating a structure of a bipolar lead-acid storage battery according to an embodiment of the present invention.

FIG. 2 is an enlarged cross-sectional view illustrating part of the structure of the bipolar lead-acid storage battery according to the embodiment of the present invention.

FIG. 3 is an enlarged cross-sectional view illustrating part of another structure regarding the structure of the bipolar lead-acid storage battery according to the embodiment of the present invention.

FIG. 4 is an enlarged cross-sectional view illustrating part of a structure in a state where a lid is attached to the bipolar lead-acid storage battery according to the embodiment of the present invention.

### DETAILED DESCRIPTION

Hereinafter, embodiments of the present invention will be described with reference to the drawings. Note that the embodiments described below illustrate examples of the present invention. Furthermore, various changes or improvements can be added to each of these embodiments, and a mode to which such changes or improvements are added can also be included in the present invention. These embodiments and modifications thereof are included in the scope of the invention described in the claims and their equivalents. Note that, hereinafter, a lead-acid storage battery will be described as an example from among various storage batteries.

### Overall Configuration

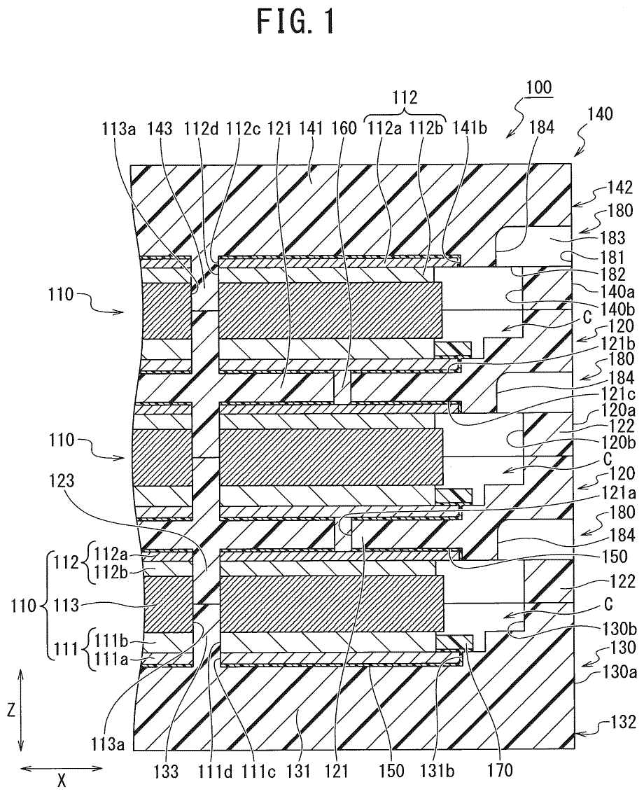

First, an overall configuration of a bipolar lead-acid storage battery in an embodiment of the present invention is described. FIG. 1 is a cross-sectional view illustrating a structure of a bipolar lead-acid storage battery 100 according to an embodiment of the present invention.

As illustrated in FIG. 1, the bipolar lead-acid storage battery 100 of a first embodiment includes a plurality of cell members 110, a plurality of bipolar plates 120 (space forming members), a first end plate 130 (space forming member), and a second end plate 140 (space forming member).

Here, although FIG. 1 illustrates the bipolar lead-acid storage battery 100 in which three cell members 110 are stacked, the number of cell members 110 is determined by battery design. The number of bipolar plates 120 is determined according to the number of cell members 110.

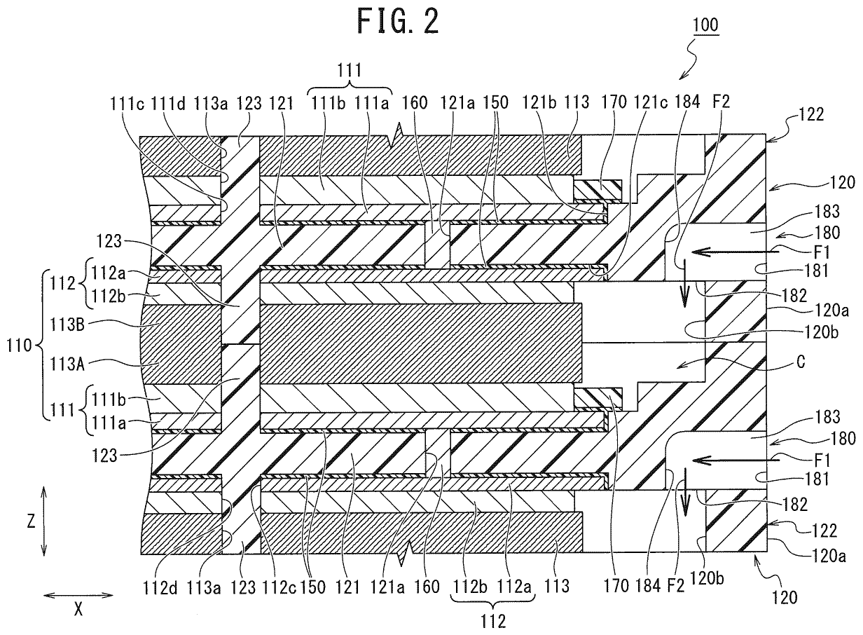

Note that, in the following, as illustrated in FIG. 1 and FIG. 2 described later, the stacking direction of the cell members 110 is defined as a Z direction (the up-down direction in FIG. 1 or FIG. 2), and directions perpendicular to the Z direction and perpendicular to each other are defined as an X direction and a Y direction. The Z direction, which is the stacking direction of the cell members 110, is parallel to the vertical direction.

The cell member 110 includes a positive electrode 111, a negative electrode 112, and an electrolyte layer or separator 113. The positive electrode 111 includes a positive electrode lead foil 111a, which is a positive electrode current collector made of lead or a lead alloy, and a positive active material layer 111b. The negative electrode 112 includes a negative electrode lead foil 112a, which is a negative electrode current collector made of lead or a lead alloy, and a negative active material layer 112b.

The positive electrode lead foil 111a is provided on one face (in FIG. 1, a face facing upward in the paper surface) of the bipolar plate 120 by an adhesive 150, which will be described later, provided between the one face of the bipolar plate 120 and the positive electrode lead foil 111a. Therefore, an adhesive layer (e.g., the adhesive 150), the positive electrode lead foil 111a, and the positive active material layer 111b are stacked in this order on the one face of the bipolar plate 120.

On the other hand, the negative electrode lead foil 112a is provided on the other face (in FIG. 1, a face facing downward in the paper surface) of the bipolar plate 120 by the adhesive 150, which will be described later, provided between the other face of the bipolar plate 120 and the negative electrode lead foil 112a. Therefore, an adhesive layer (e.g., the adhesive 150), the negative electrode lead foil 112a, and the negative active material layer 112b are stacked in this order on the other face of the bipolar plate 120. The positive electrode 111 and the negative electrode 112 are electrically connected via a conductor 160 to be described later.

The separator 113 includes, for example, a glass fiber mat impregnated with an electrolyte solution containing sulfuric acid. The separator 113 is provided to be sandwiched between the positive active material layer 111b provided on one of the bipolar plates 120 facing each other and the negative active material layer 112b provided on the other bipolar plate 120. In the cell member 110, the positive electrode lead foil 111a, the positive active material layer 111b, the separator 113, the negative active material layer 112b, and the negative electrode lead foil 112a are stacked in this order.

In the bipolar lead-acid storage battery 100 according to the embodiment having such a configuration, as described above, the bipolar plates 120, the positive electrode lead foil 111a, the positive active material layer 111b, the negative electrode lead foil 112a, and the negative active material layer 112b collectively constitute a bipolar electrode. The bipolar electrode refers to an electrode having functions of both the positive electrode and the negative electrode in one electrode.

In the bipolar lead-acid storage battery 100 according to the embodiment, the plurality of cell members 110, each of which is formed by interposing the separator 113 between the positive electrode 111 and the negative electrode 112, and the plurality of bipolar plates 120, provided in pairs to sandwich each of the cell members 110, are stacked. The outermost layer is assembled by the first end plate 130 and the second end plate 140 to have a battery configuration in which the cell members 110 are connected in series.

Dimensions in the X direction and the Y direction of the positive electrode lead foil 111a are larger than dimensions in the X direction and the Y direction of the positive active material layer 111b. Similarly, dimensions in the X direction and the Y direction of the negative electrode lead foil 112a are larger than dimensions in the X direction and the Y direction of the negative active material layer 112b. Furthermore, for a dimension in the Z direction (thickness), the positive electrode lead foil 111a is larger (thicker) than the negative electrode lead foil 112a, and the positive active material layer 111b is larger (thicker) than the negative active material layer 112b.

The plurality of cell members 110 are arranged with spacing in a stacked manner in the Z direction, and the substrates 121 of the bipolar plates 120 are arranged in portions of the spacing. That is, the plurality of cell members 110 are stacked in a state where the substrate 121 of the bipolar plate 120 is sandwiched between the cell members 110.

Thus, the plurality of bipolar plates 120, the first end plate 130, and the second end plate 140 are space forming members for forming a plurality of spaces C (cells) individually housing the plurality of cell members 110.

That is, the bipolar plate 120 is the space forming member including the substrate 121, which covers both the positive electrode 111 side and the negative electrode 112 side of the cell member 110 and has a rectangular planar shape, and a frame 122 surrounding a side face of the cell member 110 and covering the four end faces of the substrate 121.

The bipolar plate 120, which is the space forming member, has an outer wall face 120a and an inner wall face 120b. The inner wall face 120b faces the side face of the cell member 110. In other words, a part of the space C for housing the cell member 110 is defined by the inner wall face 120b. The outer wall face 120a forms a part of the outer surface of the bipolar lead-acid storage battery 100.

Furthermore, as illustrated in FIG. 1, the bipolar plate 120 further includes a column 123 perpendicularly protruding from both faces of the substrate 121. The number of columns 123 protruding from each face of the substrate 121 may be one or more.

The substrate 121, the frame 122, and the column 123 that constitute the bipolar plate 120 are integrally formed of, for example, a thermoplastic resin. Examples of the thermoplastic resin forming the bipolar plate 120 include an acrylonitrile-butadiene-styrene copolymer (ABS) resin or polypropylene. These thermoplastic resins are excellent in moldability and in sulfuric acid resistance. Hence, even when the electrolyte solution contacts the bipolar plate 120, decomposition, deterioration, corrosion, and the like hardly occur in the bipolar plate 120.

In the Z direction, a dimension of the frame 122 is larger than a dimension (thickness) of the substrate 121, and a dimension between protruding end faces of the column 123 is the same as the dimension of the frame 122. The plurality of bipolar plates 120 are stacked such that the frames 122 and the columns 123 are in contact with each other, whereby the space C is formed between the substrate 121 and the substrate 121. Then, the dimension in the Z direction of the space C is held by the columns 123 in contact with each other.

Through hole 111c is formed in the positive electrode lead foil 111a. Through hole 111d is formed in the positive active material layer 111b. Through hole 112c is formed in the negative electrode lead foil 112a. Through hole 112d is formed in the negative active material layer 112b. Through hole 113a is formed in the separator 113. Through holes 111c, 111d, 112c, 112d, and 113a allow the column 123 to penetrate therethrough.

The substrate 121 of the bipolar plate 120 has a plurality of through holes 121a penetrating the plate surface. A first recess 121b is formed on one face of the substrate 121, and a second recess 121c is formed on the other face. A depth of the first recess 121b is deeper than a depth of the second recess 121c. Dimensions in the X direction and the Y direction of the first recess 121b and the second recess 121c are made to correspond to the dimensions in the X direction and the Y direction of the positive electrode lead foil 111a and the negative electrode lead foil 112a.

The substrate 121 of the bipolar plate 120 is arranged between adjacent cell members 110 in the Z direction. The positive electrode lead foil 111a of the cell member 110 is arranged in the first recess 121b of the substrate 121 of the bipolar plate 120 via the adhesive 150. Furthermore, the negative electrode lead foil 112a of the cell member 110 is arranged in the second recess 121c of the substrate 121 of the bipolar plate 120 via the adhesive 150.

The conductor 160 is arranged in the through hole 121a of the substrate 121 of the bipolar plate 120. Both end faces of the conductor 160 are in contact with and coupled to the positive electrode lead foil 111a and the negative electrode lead foil 112a. That is, the positive electrode lead foil 111a and the negative electrode lead foil 112a are electrically connected by the conductor 160. As a result, each of the plurality of cell members 110 is electrically connected in series.

On an outer edge portion of the positive electrode lead foil 111a, a cover plate 170 for covering the outer edge portion is provided. The cover plate 170 is, for example, a thin plate-shaped frame, and has a rectangular inner shape line and outer shape line. An inner edge portion of the cover plate 170 overlaps with the outer edge portion of the positive electrode lead foil 111a, and an outer edge portion of the cover plate 170 overlaps with a peripheral edge portion of the first recess 121b of one face of the substrate 121.

That is, the rectangle forming the inner shape line of the cover plate 170 is smaller than a rectangle forming an outer shape line of the positive electrode lead foil 111a, and the rectangle forming the outer shape line of the cover plate 170 is larger than a rectangle forming an opening face of the first recess 121b.

The adhesive 150 runs around from an end face of the positive electrode lead foil 111a to an outer edge portion on the opening side of the first recess 121b, and the adhesive 150 is arranged between the inner edge portion of the cover plate 170 and the outer edge portion of the positive electrode lead foil 111a. Furthermore, the adhesive 150 is also arranged between the outer edge portion of the cover plate 170 and one face of the substrate 121.

That is, the cover plate 170 is fixed by the adhesive 150 over the peripheral edge portion of the first recess 121b on one face of the substrate 121 and the outer edge portion of the positive electrode lead foil 111a. Thus, the outer edge portion of the positive electrode lead foil 111a is covered with the cover plate 170 also in a boundary portion with the peripheral edge portion of the first recess 121b.

Note that, although not illustrated in FIG. 1, an outer edge portion of the negative electrode lead foil 112a may also be covered with a cover plate similar to the cover plate 170 covering an outer edge portion of the positive electrode lead foil 111a. Furthermore, the cover plate has been described as an example of a thin plate-shaped frame, but, for example, a tape-shaped object or the like may be used as long as the cover plate has electrolyte solution resistance (e.g., sulfuric acid resistance).

As illustrated in FIG. 1, the first end plate 130 is a space forming member including a substrate 131 covering the positive electrode side of the cell member 110 and a frame 132 surrounding a side face of the cell member 110. Furthermore, a column 133 vertically protruding from one face of the substrate 131 (a face facing the substrate 121 of the bipolar plate 120 arranged most on the positive electrode side) is provided.

The first end plate 130, which is the space forming member, has an outer wall face 130a and an inner wall face 130b. The inner wall face 130b faces the side face of the cell member 110.

The substrate 131 has a rectangular planar shape. Four end faces of the substrate 131 are covered with the frame 132. The substrate 131, the frame 132, and the column 133 are integrally formed of, for example, the above-described thermoplastic resin. Note that the number of columns 133 protruding from each face of the substrate 131 may be one or more. However, the number corresponds to the number of columns 133 of the bipolar plate 120 to be brought into contact with the columns 123.

In the Z direction, a dimension of the frame 132 is larger than a dimension (thickness) of the substrate 131, and a dimension between protruding end faces of the column 133 is the same as the dimension of the frame 132. The first end plate 130 is stacked such that the frame 132 and the column 133 are in contact with the frame 122 and the column 123 of the bipolar plate 120 arranged on the outermost side (e.g., the positive electrode side).

Thus, the space C is formed between the substrate 121 of the bipolar plate 120 and the substrate 131 of the first end plate 130. Furthermore, a dimension in the Z direction of the space C is held by the column 123 of the bipolar plate 120 and the column 133 of the first end plate 130 in contact with each other.

The through holes 111c, 111d, and 113a allowing the column 133 to penetrate are formed in the positive electrode lead foil 111a, the positive active material layer 111b, and the separator 113 of the cell member 110 arranged on the outermost side (e.g., positive electrode side), respectively.

A recess 131b is formed on one face of the substrate 131 of the first end plate 130. Dimensions in the X direction and the Y direction of the recess 131b are made to correspond to the dimensions in the X direction and the Y direction of the positive electrode lead foil 111a.

The positive electrode lead foil 111a of the cell member 110 is arranged in the recess 131b of the substrate 131 of the first end plate 130 via the adhesive 150. Furthermore, the cover plate 170 is fixed to one face side of the substrate 131 by the adhesive 150 like on the substrate 121 of the bipolar plate 120. As a result, the outer edge portion of the positive electrode lead foil 111a is covered with the cover plate 170 also in a boundary portion with a peripheral edge portion of the recess 131b.

Furthermore, the first end plate 130 includes a positive electrode terminal (not illustrated in FIG. 1) electrically connected to the positive electrode lead foil 111a in the recess 131b.

The second end plate 140 is a space forming member including a substrate 141 covering the negative electrode side of the cell member 110 and a frame 142 surrounding a side face of the cell member 110. Furthermore, a column 143 vertically protruding from one face of the substrate 141 (a face facing the substrate 121 of the bipolar plate 120 arranged most on the negative electrode side) is provided.

The second end plate 140, which is the space forming member, has an outer wall face 140a and an inner wall face 140b, and the inner wall face 140b faces the side face of the cell member 110.

The substrate 141 has a rectangular planar shape. Four end faces of the substrate 141 are covered with the frame 142. The substrate 141, the frame 142, and the column 143 are integrally formed of, for example, the above-described thermoplastic resin. Note that the number of columns 143 protruding from each face of the substrate 141 may be one or more. However, the number corresponds to the number of columns 123 of the bipolar plate 120 to be brought into contact with the columns 143.

In the Z direction, a dimension of the frame 142 is larger than a dimension (thickness) of the substrate 141, and a dimension between protruding end faces of the two columns 143 is the same as the dimension of the frame 142. The second end plate 140 is stacked such that the frame 142 and the column 143 are in contact with the frame 122 and the column 123 of the bipolar plate 120 arranged on the outermost side (the negative electrode side).

Thus, the space C is formed between the substrate 121 of the bipolar plate 120 and the substrate 141 of the second end plate 140. Furthermore, a dimension in the Z direction of the space C is held by the column 123 of the bipolar plate 120 and the column 143 of the second end plate 140 in contact with each other.

The through holes 112c, 112d, and 113a allowing the column 143 to penetrate are formed in the negative electrode lead foil 112a, the negative active material layer 112b, and the separator 113 of the cell member 110 placed on the outermost side (e.g., the negative electrode side), respectively.

A recess 141b is formed on one face of the substrate 141 of the second end plate 140. Dimensions in the X direction and the Y direction of the recess 141b are made to correspond to the dimensions in the X direction and the Y direction of the negative electrode lead foil 112a.

The negative electrode lead foil 112a of the cell member 110 is arranged in the recess 141b of the substrate 141 of the second end plate 140 via the adhesive 150. Furthermore, the second end plate 140 includes a negative electrode terminal (not illustrated in FIG. 1) electrically connected to the negative electrode lead foil 112a in the recess 141b.

When joining the bipolar plates 120 facing each other, the first end plate 130 and the facing bipolar plate 120, or the second end plate 140 and the facing bipolar plate 120, various welding methods such as vibration welding, ultrasonic welding, or hot plate welding can be employed. Vibration welding is performed by vibrating faces to be joined while pressurizing the faces at the time of joining and has a fast cycle of welding and good reproducibility. Therefore, vibration welding is more preferably used.

Note that objects to be welded include not only frames but also the respective columns arranged in facing positions on facing bipolar plates 120, the first end plate 130, and the second end plate 140.

The bipolar lead-acid storage battery 100 includes a through hole 180 for injecting the electrolyte solution into the space C housing the cell member 110. The through hole 180 is formed in one of four end faces of the bipolar plate 120, the first end plate 130, and the second end plate 140.

Here, FIG. 2 is an enlarged cross-sectional view illustrating part of the structure of the bipolar lead-acid storage battery 100 according to this embodiment. In FIG. 2, the cell member 110 sandwiched between the two bipolar plates 120 is illustrated at the center, and the through hole 180 communicating with the space C formed by the two adjacent bipolar plates 120 is illustrated on the right side.

Taking the bipolar plate 120 as an example, the through hole 180 formed on the right side in FIGS. 1 and 2, for example, includes an outer opening 181 open on the outer wall face 120a of the bipolar plate 120 and an inner opening 182 open on the inner wall face 120b of the bipolar plate 120. A wall portion 184 is provided in at least a part of a through path 183 connecting the outer opening 181 and the inner opening 182. The electrolyte solution is injected into the outer opening 181 and injected into the space C from the inner opening 182 through the through path 183.

Note that, similarly, the first end plate 130 includes the outer opening 181 open on the outer wall face 130a and the inner opening 182 open on the inner wall face 130b. The through path 183 is formed to connect the outer opening 181 and the inner opening 182.

The second end plate 140 also includes the outer opening 181 open on the outer wall face 140a and the inner opening 182 open on the inner wall face 140b. The through path 183 is formed to connect the outer opening 181 and the inner opening 182.

During injection into the space C, the electrolyte solution is injected with the X direction illustrated in FIG. 1 being a direction parallel to the vertical direction. On the other hand, when in use, the bipolar lead-acid storage battery 100 is placed with the Z direction, which is the stacking direction, being a direction parallel to the vertical direction, for example, as illustrated in FIGS. 1 and 2.

Note that, in the placement in which the Z direction is parallel to the vertical direction as described above, the positive electrode 111 of the bipolar lead-acid storage battery 100 is placed to face downward in the vertical direction as illustrated in FIG. 1. In other words, when the bipolar lead-acid storage battery 100 is placed such that the stacking direction (Z direction) of the cell member 110 and the space forming members (e.g., the bipolar plate 120, the first end plate 130, and the second end plate 140) is a direction parallel to the vertical direction, the positive electrode 111 is arranged below the negative electrode 112 in the stacking direction.

Here, regarding charging and discharging of the bipolar lead-acid storage battery 100, oxygen (O₂) becomes water (H₂O) when discharging is performed in the bipolar lead-acid storage battery 100. Conversely, electrolysis of water (H₂O) occurs when charging is performed. Therefore, the negative electrode 112 is preferably arranged on the upper side of the positive electrode 111 in the stacking direction to facilitate movement of oxygen (O₂) to the negative electrode 112.

Furthermore, when charging and discharging are performed, a phenomenon called softening of the positive active material layer 111b occurs in the positive electrode 111. When such softening occurs, coupling between the positive electrode lead foil 111a and the positive active material layer 111b is weakened, and the adhesion therebetween is deteriorated.

As a result, the electrolyte solution is likely to enter between the positive active material layer 111b and the positive electrode lead foil 111a, and there is a possibility that the positive active material layer 111b is peeled off. Therefore, to avoid the occurrence of such a state, the positive electrode 111 is placed on the lower side in the vertical direction when the bipolar lead-acid storage battery 100 is placed such that the Z direction is parallel to the vertical direction for use.

The outer opening 181 of the through hole 180 is provided to open on the outer wall face (e.g., the outer wall face 120a, the outer wall face 130a, or the outer wall face 140a) of the space forming member (e.g., the bipolar plate 120, the first end plate 130, or the second end plate 140).

In the case of the bipolar lead-acid storage battery 100 according to the embodiment, for example, when the space forming member is the bipolar plate 120, the outer opening 181 is formed between one face, on which the positive electrode 111 is provided, and the other face, on which the negative electrode 112 is provided. That is, the outer opening 181 is formed on the outer wall face 120a of the substrate 121 including at least a part of a distance between the first recess 121b in the bipolar plate 120, where the positive electrode lead foil 111a is provided, and the second recess 121c, where the negative electrode lead foil 112a is provided.

That is, for example, when description is given with reference to FIG. 2, the outer opening 181 is open on the outer wall face 120a of the bipolar plate 120 and is formed on an extension line of the substrate 121 in the X direction. That is, the outer opening 181 of the through hole 180 is not formed on an extension line of the separator 113 in the X direction but is formed at a position offset from the extension line.

By being formed on the extension line of the substrate 121 in the X direction in this manner, the outer opening 181 has an opening distance in the Z direction that includes a part of the distance between the first recess 121b and the second recess 121c indicated as a thickness of the bipolar plate 120 in the Z direction.

On the other hand, in the through hole 180, the inner opening 182 communicating with the space C on the inner wall face (e.g., the inner wall face 120b, the inner wall face 130b, or the inner wall face 140b) of the space forming member is not formed on an extension line of the separator 113 in the X direction as in injection holes of the related art. For example, in the case of the bipolar lead-acid storage battery 100 illustrated in FIG. 2, an opening position of the inner opening 182 is formed to be flush with a face of the substrate 121 where the negative electrode lead foil 112a and the negative active material layer 112b are in contact with each other.

The wall portion 184 is provided in at least a part of the through path 183. In the bipolar lead-acid storage battery 100 illustrated in FIG. 2, the wall portion 184 is formed such that a distance in the Z direction is substantially the same as a distance of the outer opening 181 in the Z direction. Therefore, most of the electrolyte solution injected from the outer opening 181 contacts the wall portion 184, changes its direction due to the contact with the wall portion 184, and enters the space C from the inner opening 182.

That is, for example, taking the bipolar plate 120 as an example, injection holes of the related art through which an electrolyte solution is injected are provided to be linear and coaxial in the X direction of the bipolar lead-acid storage battery 100 from the outer wall face 120a toward the inner wall face 120b. The through path 183 becomes the shortest when being formed in the X direction between the outer wall face 120a and the inner wall face 120b to be perpendicular to the Z direction as described above.

On the other hand, in the bipolar lead-acid storage battery 100 described here, the outer opening 181 and the inner opening 182 of the through hole 180 are not provided to be linear and coaxial in the X direction of the bipolar lead-acid storage battery 100.

That is, the wall portion 184 is formed in at least a part of the through path 183 connecting the outer opening 181 and the inner opening 182 in the bipolar lead-acid storage battery 100 as described above. Because the wall portion 184 is formed in this manner, the electrolyte solution injected into the bipolar lead-acid storage battery 100 hits the wall portion 184 and changes its direction before entering the space C.

Specifically, the electrolyte solution flowing in from the outer opening 181 flows in a direction of an arrow illustrated to be parallel to the X direction in FIG. 2 (hereinafter, such a flowing direction of the electrolyte solution flowing in from the outer opening 181 is appropriately referred to as a “first flow direction F1”). Thereafter, the electrolyte solution comes into contact with the wall portion 184, changes its flowing direction to a direction of an arrow illustrated to be parallel to the Z direction in FIG. 2, and flows out into the space C from the inner opening 182 (hereinafter, such a direction in which the electrolyte solution flows out from the inner opening 182 into the space C is appropriately referred to as a “second flow direction F2”).

Therefore, the flowing directions (e.g., the first flow direction F1 and the second flow direction F2) of the electrolyte solution are different between an inlet (e.g., the outer opening 181) and an outlet (e.g., the inner opening 182) of the through path 183. This is because the injected electrolyte solution contacts the wall portion 184 in the middle of the through path 183. A momentum of the electrolyte solution is weakened due to the contact with the wall portion 184. Therefore, the momentum of the electrolyte solution injected into the space C can be reduced.

Note that, in the case of the bipolar lead-acid storage battery 100 illustrated in FIG. 2, the distance of the wall portion 184 in the Z direction is substantially the same as the distance of the outer opening 181 in the Z direction as described above. Furthermore, the opening position of the inner opening 182 is formed to be flush with the face of the substrate 121 where the negative electrode lead foil 112a and the negative active material layer 112b are in contact with each other. Therefore, when viewed from the outer opening 181 to be parallel to the X direction, the wall portion 184 is visible at the front in the X direction from the outer opening 181, and the inner opening 182 is not visible.

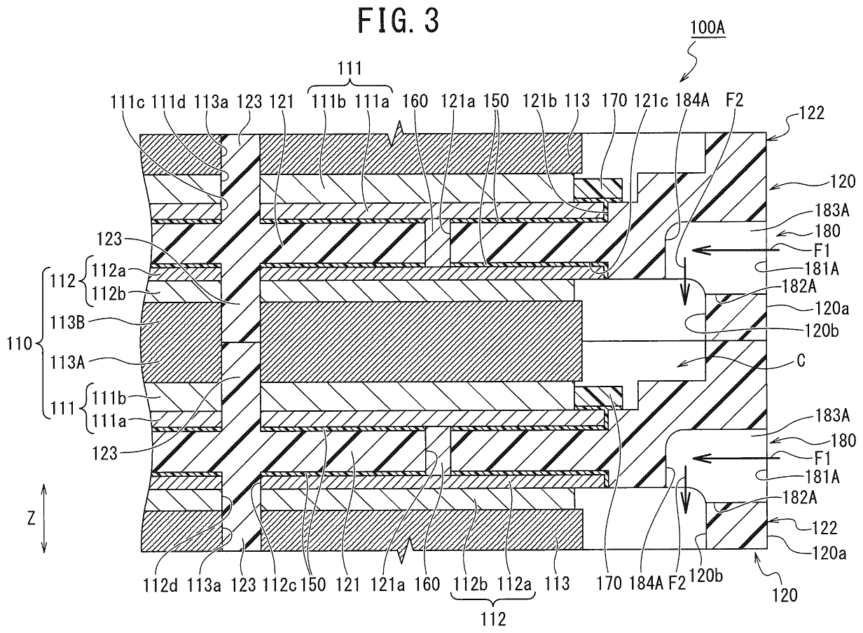

However, the relationship between the wall portion 184 and the outer opening 181 is not necessarily the relationship described above. Here, FIG. 3 is an enlarged cross-sectional view illustrating part of another structure of a bipolar lead-acid storage battery 100A according to an embodiment of the present invention.

In the case of the bipolar lead-acid storage battery 100A illustrated in FIG. 3, a distance of the wall portion 184 in the Z direction is shorter than a distance of an outer opening 181A in the Z direction. That is, when viewed from the outer opening 181A to be parallel to the X direction, not only a wall portion 184A but also an inner opening 182A are visible at the front in the X direction from the outer opening 181A, and a part of the space C is also visible.

Therefore, a through path 183A illustrated in FIG. 3 is in a state where the wall portion 184A is provided in at least a part thereof, which is different from the through path 183 illustrated in FIG. 2. Therefore, not all of an electrolyte solution flowing in the first flow direction F1 from the outer opening 181A contacts the wall portion 184A, but a part thereof does contact the wall portion 184A. The flow direction is changed by the wall portion 184A to the second flow direction F2, so that the electrolyte solution is mixed with the other part of the electrolyte solution not contacting the wall portion 184A.

Therefore, the electrolyte solution flowing in from the outer opening 181A is divided into an electrolyte solution in which a momentum has been reduced due to the contact with the wall portion 184A and the flowing direction has been changed from the first flow direction F1 to the second flow direction F2, and an electrolyte solution that maintains the momentum at the time of injection without coming into contact with the wall portion 184A. However, both are mixed with each other when flowing into the space C, and as a result, a momentum of an electrolyte solution flowing into the space C can be weakened.

Note that the wall portion 184 is provided in a clear form in the through path 183 illustrated in FIG. 2 and the through path 183A illustrated in FIG. 3. However, even if the wall portion 184 is not clear, the momentum of the electrolyte solution flowing out to the space C can be weakened, for example, by providing the through path 183 to not be parallel to an injection direction of the electrolyte solution.

That is, the electrolyte solution is injected in the direction parallel to the X direction when the injection into the space C is performed as described above. However, because at least a part of the through path 183 is formed to not be parallel to this injection direction, the electrolyte solution flowing in from the outer opening 181 contacts any portion (e.g., the wall portion 184) constituting an inner wall face of the through path 183. Therefore, at least a part of the injected electrolyte solution can have an inflow direction (e.g., the first flow direction F1) different from an outflow direction (e.g., the second flow direction F2). Therefore, it is possible to reduce the momentum of the electrolyte solution at the time of injection, and it is possible to reduce the possibility that the electrolyte solution directly contacts the separator 113.

Because the through hole 180 is formed such that the electrolyte solution injected in this manner cannot directly enter the space C from the outer opening 181, it is possible to avoid deformation or breakage of components of the cell member 110 due to the pressure at the time of injecting the electrolyte solution. As a result, it is possible to prevent occurrence of a short circuit between the positive electrode side and the negative electrode side inside the cell member 110 and to prevent deterioration in performance of the bipolar lead-acid storage battery 100.

Because the outer opening 181 and the inner opening 182 are arranged such that the through hole 180 satisfies such a condition, the opening of the through hole 180 is not located on an extension line in the X direction of the separator 113. Thus, even if an electrolyte solution is injected into the space C, direct contact of the electrolyte solution with the separator 113 is avoided. Furthermore, the electrolyte solution can be prevented from vigorously contacting the separator 113 even if direct contact is made. Therefore, the pressure due to the injection of the electrolyte solution is not applied to the separator 113 or is reduced, and thus, the separator 113 is not deformed or the like.

Note that, if an outer opening is formed on an outer wall face of a frame, a length of the frame in the Z direction, that is, a thickness when the bipolar lead-acid storage battery 100 is placed in the stacking direction, needs to be set to a thickness that can form the opening. This leads to an increase in the thickness of the frame, and as a result, a size of the bipolar lead-acid storage battery 100 in the Z direction increases.

Meanwhile, the substrate 121 is present in the X direction of the frame 122 of the bipolar plate 120. Therefore, it is difficult to form injection holes of the related art in the frame 122 on the extension line of the substrate 121 in the X direction and to provide an inner opening on the inner side thereof in the X direction.

On the other hand, in the through hole 180 of the bipolar lead-acid storage battery 100 illustrated herein, for example, the outer opening 181 is formed on the outer wall face 120a of the bipolar plate 120 on the extension line of the substrate 121 in the X direction. As a result, it is possible to utilize a region of the bipolar plate 120 on the extension line of the substrate 121 in the X direction, the region being a so-called dead space in the related art.

Because the outer opening 181 is formed at this position, the thickness of the frame surrounding the space C can be reduced (i.e., the distance in the Z direction can be shortened). Therefore, because the distance of the bipolar lead-acid storage battery 100 in the Z direction can be reduced as a whole, the bipolar lead-acid storage battery 100 can be made compact and space-saving.

The outer opening 181 is formed on the outer wall face 120a of the bipolar plate 120 on the extension line of the substrate 121 in the X direction, and thus, the opening can also be widened in the Z direction. Therefore, it is possible to form the outer opening 181 having a larger opening than injection holes of the related art, and the electrolyte solution can be more smoothly injected into the space C.

The inner opening 182 is open on the inner wall face of the space forming member toward the space C as in the related art. Therefore, the injection of the electrolyte solution can be performed as in the related art, and further, the above-described disadvantage due to the injection of the electrolyte solution can be avoided because its opening face is not on the extension line of the separator 113 in the X direction.

Note that the through hole 180 described herein is formed in such a shape, but does not necessarily have such a shape as long as the injected electrolyte solution does not directly contact components of the cell member 110 or an entering momentum of the electrolyte solution is weakened by a structure.

For example, the direction of the electrolyte solution when the electrolyte solution is injected from the outer opening 181 is not necessarily different from the direction of the electrolyte solution entering the space C from the inner opening 182 as in the bipolar lead-acid storage battery 100. That is, for example, even if the opening faces of the outer opening 181 and the inner opening 182 face the same direction, the opening face of the outer opening 181 and the opening face of the inner opening 182 can be arranged to be misaligned such that the electrolyte solution entering from the inner opening 182 does not come into direct contact with the components.

It is also possible to adopt, for example, a structure in which the electrolyte solution can be injected to contact a component other than the separator 113 arranged in the space C, the component having strength higher than that of the separator 113, such as the cover plate 170, when the electrolyte solution is injected into the space C.

It is sufficient for the through hole 180 to have a structure of penetrating from the outer opening 181 toward the inner opening 182. Therefore, it is also possible to adopt, for example, a structure in which the through path 183 is formed in a U-shape or a spiral shape, or the electrolyte solution is intermittently injected into the space C. Alternatively, the through path 183 may be bent or curved in the middle.

The inner opening 182 of the through hole 180 is formed on one face or the other face of the substrate 121. In the embodiment, the inner opening 182 is formed to be flush with a joint face between the negative electrode lead foil 112a and the negative active material layer 112b. Similarly, at a lower end in the Z direction of the opening face of the outer opening 181 of the through hole 180, the inner opening 182 is flush with the joint face between the negative electrode lead foil 112a and the negative active material layer 112b.

Therefore, it is possible to reduce the possibility that the electrolyte solution injected into the space C leaks to the outside through the through hole 180 even when the bipolar lead-acid storage battery 100 is placed in the direction of the Z direction illustrated in FIG. 1 or FIG. 2, which is the stacking direction, during the use of the bipolar lead-acid storage battery 100.

Note that, here, the lower end in the Z direction of the opening face of the outer opening 181 of the through hole 180 is flush with the joint face between the negative electrode lead foil 112a and the negative active material layer 112b on which the inner opening 182 is formed. However, such a lower end portion (e.g., the opening position of the outer opening 181) can also be provided, for example, above the opening position of the inner opening 182 in the direction in which the stacking direction of the cell member 110 and the space forming member, here a bipolar plate 120, is parallel to the vertical direction. That is, the lower end is arranged on the upper side in the stacking direction, such as at a position flush with the second recess 121c in the substrate 121 of the bipolar plate 120. This can further reduce the possibility that the electrolyte solution leaks to the outside through the through hole 180.

As described above, the opening position of the inner opening 182 in the embodiment is formed to be flush with the face of the substrate 121 where the negative electrode lead foil 112a and the negative active material layer 112b are in contact with each other. However, the opening position of the inner opening 182 is not necessarily formed in this manner. That is, for example, the opening position of the inner opening 182 can also be formed on the upper side in the stacking direction of the face of the substrate 121 where the negative electrode lead foil 112a and the negative active material layer 112b are in contact with each other.

Although arrangement positions and the like of the outer opening 181 and the inner opening 182 have been described so far, opening shapes of the outer opening 181 and the inner opening 182 can be, for example, circular or elliptical. Furthermore, diameters of these openings can be set to, for example, 1 mm to 5 mm.

### Manufacturing Method

The bipolar lead-acid storage battery 100 of this embodiment can be manufactured by, for example, a method including each of steps to be described hereinafter.

### Step of Producing Bipolar Plate Equipped with Positive Electrode Lead Foil and Negative Electrode Lead Foil

First, the substrate 121 of the bipolar plate 120 is placed on a worktable with the first recess 121b side facing upward. Then, the adhesive 150 is applied to the first recess 121b, and the positive electrode lead foil 111a is placed in the first recess 121b. At this time, the column 123 of the bipolar plate 120 is set to pass through the through hole 111c of the positive electrode lead foil 111a. The adhesive 150 is cured to attach the positive electrode lead foil 111a to one face of the substrate 121.

Next, the substrate 121 is placed on the worktable with the second recess 121c side facing upward, and the conductor 160 is inserted into the through hole 121a. Then, the adhesive 150 is applied to the second recess 121c, and the negative electrode lead foil 112a is put in the second recess 121c. At this time, the column 123 of the bipolar plate 120 is set to pass through the through hole 112c of the negative electrode lead foil 112a. The adhesive 150 is cured to attach the negative electrode lead foil 112a to the other face of the substrate 121.

Next, the substrate 121 is placed on the worktable with the first recess 121b side facing upward. Then, the adhesive 150 is applied onto an outer edge portion of the positive electrode lead foil 111a and an upper face of the substrate 121 to be an edge portion of the first recess 121b, the cover plate 170 is placed thereon, and the adhesive 150 is cured. Thus, the cover plate 170 is fixed over the outer edge portion of the positive electrode lead foil 111a and a portion of the substrate 121 continuous to the outside thereof (a peripheral edge portion of the first recess 121b).

Next, resistance welding is performed to connect the conductor 160, the positive electrode lead foil 111a, and the negative electrode lead foil 112a. Thus, the bipolar plate 120 equipped with positive electrode lead foil and negative electrode lead foil is obtained. A desired number of the bipolar plates 120 equipped with positive electrode lead foil and negative electrode lead foil are prepared. Step of Producing End Plate Equipped with Positive Electrode Lead Foil

The substrate 131 of the first end plate 130 is placed on a worktable with the recess 131b side facing upward. Then, the adhesive 150 is applied to the recess 131b, the positive electrode lead foil 111a is placed in the recess 131b, and the adhesive 150 is cured. At this time, the column 133 of the end plate 130 is set to pass through the through hole 111c of the positive electrode lead foil 111a. The adhesive 150 is cured to attach the positive electrode lead foil 111a to one face of the substrate 131.

Next, the adhesive 150 is applied onto an outer edge portion of the positive electrode lead foil 111a and an upper face of the substrate 131 to be an edge portion of the recess 131b. The cover plate 170 is placed on the adhesive 150, and the adhesive 150 is cured. Thus, the cover plate 170 is fixed over the outer edge portion of the positive electrode lead foil 111a and a portion of the substrate 131 continuous to the outside thereof. Thus, an end plate equipped with a positive electrode lead foil is obtained.

### Step of Producing End Plate Equipped with Negative Electrode Lead Foil

The substrate 141 of the second end plate 140 is placed on a worktable with the recess 141b side facing upward. Then, the adhesive 150 is applied to the recess 141b, the negative electrode lead foil 112a is placed in the recess 141b, and the adhesive 150 is cured. At this time, the column 143 of the second end plate 140 is set to pass through the through hole 112c of the negative electrode lead foil 112a. The adhesive 150 is cured to obtain the second end plate 140 equipped with the negative electrode lead foil 112a attached to one face of the substrate 141.

### Step of Stacking and Joining Plates

First, the first end plate 130 to which the positive electrode lead foil 111a and the cover plate 170 are fixed is placed on a worktable with the positive electrode lead foil 111a facing upward. Then, the positive active material layer 111b is placed in the cover plate 170 and is positioned on the positive electrode lead foil 111a. At this time, the column 133 of the first end plate 130 is set to pass through the through hole 111d of the positive active material layer 111b. Next, the separator 113 and the negative active material layer 112b are placed on the positive active material layer 111b.

Next, on the first end plate 130 in this state, the negative electrode lead foil 112a side of the bipolar plate 120 equipped with positive electrode lead foil and negative electrode lead foil is placed to face downward. At this time, the column 123 of the bipolar plate 120 is set to pass through the through hole 113a of the separator 113 and the through hole 112d of the negative active material layer 112b, and the column 123 is positioned on the column 133 of the first end plate 130. Then, the frame 122 of the bipolar plate 120 is put on the frame 132 of the first end plate 130.

In this state, the first end plate 130 is fixed, and vibration welding is performed while the bipolar plate 120 is vibrated in a diagonal direction of the substrate 121. Thus, the frame 122 of the bipolar plate 120 is joined onto the frame 132 of the first end plate 130. Furthermore, the column 123 of the bipolar plate 120 is joined onto the column 133 of the first end plate 130.

As a result, the bipolar plate 120 is joined onto the first end plate 130 to form a coupled body. A state is formed in which the cell member 110 is arranged in the space C formed by the first end plate 130 and the bipolar plate 120, and the positive electrode lead foil 111a is exposed on an upper face of the bipolar plate 120.

Next, the positive active material layer 111b, the separator 113, and the negative active material layer 112b are placed in this order on the coupled body. After that, another bipolar plate 120 equipped with positive electrode lead foil and negative electrode lead foil is placed with the negative electrode lead foil 112a side facing downward.

In this state, the coupled body is fixed, and vibration welding is performed while another bipolar plate 120 equipped with positive electrode lead foil and negative electrode lead foil is vibrated in a diagonal direction of the substrate 121. This stacking and vibration welding step is continually performed until the required number of bipolar plates 120 are joined onto the first end plate 130.

Finally, the positive active material layer 111b, the separator 113, and the negative active material layer 112b are placed in this order on the uppermost bipolar plate 120 of the coupled body in which all the bipolar plates 120 are joined. After that, the second end plate 140 is further placed with the negative electrode lead foil 112a side facing downward.

In this state, the coupled body is fixed, and vibration welding is performed while the second end plate 140 is vibrated in a diagonal direction of the substrate 141. Thus, the second end plate 140 is joined onto the uppermost bipolar plate 120 of the coupled body in which all the bipolar plates 120 are joined.

Note that the flow of performing stacking sequentially from the first end plate 130 toward the second end plate 140 has been described in the above description. However, this stacking order may be conversely set such that stacking is performed sequentially from the second end plate 140 toward the first end plate 130.

### Step of Injection and Chemical Conversion

In the above step of stacking and joining the respective plates, a joining structure is formed by vibration welding of facing faces of frames. The through hole 180 is formed in a space forming member such that the inner opening 182 is formed at a position of each of the spaces C on one end face of the bipolar lead-acid storage battery 100 in the X direction, for example. A predetermined amount of an electrolyte solution is injected into each of the spaces C using the through hole 180, and the separator 113 is impregnated with the electrolyte solution. Then, chemical conversion is performed under predetermined conditions. Thereby, the bipolar lead-acid storage battery 100 can be produced.

Although the through hole 180 of the bipolar lead-acid storage battery 100 has been described above, a case where the bipolar lead-acid storage battery 100 is covered with a lid will also be described.

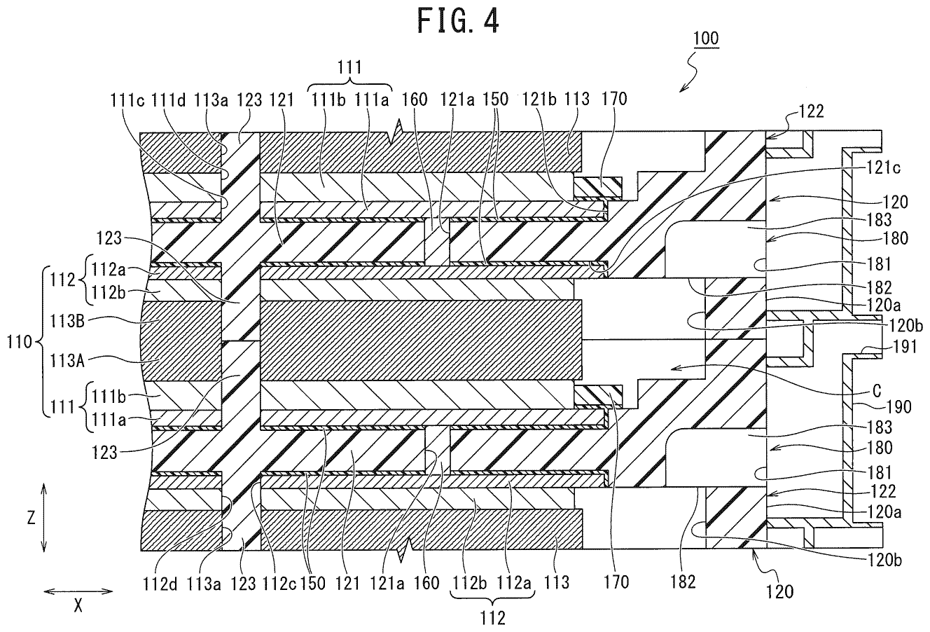

FIG. 4 is an enlarged cross-sectional view illustrating part of a structure in a state where a lid 190 is attached to the bipolar lead-acid storage battery 100 according to an embodiment of the present invention. Note that, in FIG. 4, only structures necessary for injecting the electrolyte solution into the space C among structures of the lid 190 is drawn. Therefore, other structures of the lid 190 are omitted.

The lid 190 is provided with at least one communication hole 191. The communication hole 191 serves as a through hole that is used for injecting the electrolyte solution into the space C. That is, after the lid 190 is attached to the bipolar lead-acid storage battery 100, the electrolyte solution is injected into the communication hole 191, through the through hole 180, and into the space C.

After a necessary (e.g., adequate) amount of the electrolyte solution is injected, the communication hole 191 is sealed. Therefore, after manufacturing, the communication hole 191 serves as an exhaust port for exhausting gas generated in the space C housing the cell member 110.

Here, an opening shape of the communication hole 191 can be, for example, a circular shape or an elliptical shape. Furthermore, a diameter of this opening can be, for example, 4 mm to 10 mm.

The communication hole 191 is arranged at a position as will be described below. That is, when being used, the bipolar lead-acid storage battery 100 is placed such that the Z direction, which is the stacking direction, is parallel to the vertical direction as described above. When the bipolar lead-acid storage battery 100 is placed as described above, the communication hole 191 is formed to be located above a position of the outer opening 181 of the through hole 180 in the Z direction.

As described above, when the bipolar lead-acid storage battery 100 is placed such that the stacking direction is parallel to the vertical direction during the use, the communication hole 191 is arranged at the position higher than the through hole 180 in the Z direction. Therefore, even if the electrolyte solution leaks from the through hole 180, it is possible to prevent leakage from the lid 190 to the outside.

The relationship between the through hole 180 and the communication hole 191 of the lid 190 is set, for example, as follows. Here, a cross-sectional area of a cross section of the through hole 180 orthogonal to the injection direction of the electrolyte solution is defined as a first opening area a1. Therefore, for example, when a plurality of the through holes 180 are provided, a total opening area of the through holes 180 is “the number of the plurality of provided through holes 180×a1”.

On the other hand, a cross-sectional area of a cross section of one communication hole 191 provided in the lid 190 orthogonal to the injection direction of the electrolyte solution is defined as a second opening area a2. Here, a value grasped as a “cross-sectional area” for both the first opening area a1 and the second opening area a2 is a value at which the cross-sectional area is the smallest in the through hole 180 and the communication hole 191.

Then, at this time, the relationship between the first opening area a1 and the second opening area a2 is “the number of the plurality of provided through holes 180×a1≥a2”. That is, the total opening area of the first opening areas a1 of the through holes 180 is equal to or larger than the second opening area a2 of the communication hole 191.

More specifically, the total opening area of the first opening areas a1 is 1.5 times or more and 4 times or less (i.e., between 1.5 and 4 times, inclusive) the second opening area a2. Meanwhile, the first opening area a1, which is the cross-sectional area of each of the through holes 180, is 0.5 times or more and less than 4 times the second opening area a2.

As described above, the relationship between the through hole 180 and the communication hole 191 of the lid 190 is set such that the opening area of the through hole 180 (e.g., total opening area of the plurality of through holes 180) is equal to or larger than the total opening area (second opening area) of the communication hole 191, whereby the openings communicating with space C can be made large.

That is, when the electrolyte solution is injected into the space C of the bipolar lead-acid storage battery 100 from the communication hole 191, the electrolyte solution is dispersed in each of the through holes 180, so that the momentum of the electrolyte solution can be weakened. Therefore, it is possible to minimize an influence of the pressure of the electrolyte solution on the cell member 110 during injection. Furthermore, because the electrolyte solution is injected into the space C through any one of the through holes 180, it is possible to avoid an increase in time required for the injection.

Note that the bipolar lead-acid storage battery 100 has been described as an example of an embodiment of the present invention. However, when the above description applies to other storage batteries in which other metals are used instead of lead for current collectors, the application of the above description is not excluded, as a matter of course.

Note that the technology described in the embodiment of the present invention can also adopt the following configurations.

(1) A bipolar storage battery including:
a plurality of cell members stacked with spacing, each of the cell members including a positive electrode including a positive electrode current collector and a positive active material layer, a negative electrode including a negative electrode current collector and a negative active material layer, and a separator interposed between the positive electrode and the negative electrode;
a space forming member forming a plurality of spaces individually housing the plurality of cell members, the space forming member including a substrate covering at least one of the positive electrode side and the negative electrode side of each of the cell members, and a frame surrounding a side face of each of the cell members; and
a through hole communicating with the space housing the cell member, wherein the through hole has an outer opening open on an outer wall face of the space forming member and an inner opening open on an inner wall face of the space forming member, and has a wall portion in at least a part of a through path connecting the outer opening and the inner opening, the wall portion making a first flow direction of an electrolyte solution flowing in from the outer opening different from a second flow direction in which the electrolyte solution flows out from the inner opening into the space.

(2) The bipolar storage battery according to (1), wherein the outer opening is formed on an outer wall face of the substrate including at least a part of a distance between one face of the substrate on which the positive electrode is provided and the other face of the substrate on which the negative electrode is provided.

(3) The bipolar storage battery according to (1) or (2), wherein the inner opening is formed on the one face or the other face of the substrate.

(4) The bipolar storage battery according to any one of (1) to (3), wherein the inner opening is provided at a position preventing the electrolyte solution from coming into direct contact with the separator when the electrolyte solution is injected into the space.

(5) The bipolar storage battery according to any one of (1) to (4), wherein, when the bipolar storage battery is placed in such a manner that a stacking direction of the cell members and the space forming member is parallel to a vertical direction, an opening position of the outer opening is above an opening position of the inner opening in the stacking direction.

(6) The bipolar storage battery according to any one of (1) to (5), further including a lid covering a portion of the frame, the portion surrounding one side face of the cell member, wherein the lid has a communication hole communicating with the through hole, and, when the bipolar storage battery is placed in such a manner that a stacking direction of the cell members and the space forming member is parallel to a vertical direction, an opening position of the communication hole is above an opening position of the outer opening of the through hole in the stacking direction.

(7) The bipolar storage battery according to any one of (1) to (6), wherein, when the bipolar storage battery is placed in such a manner that a stacking direction of the cell members and the space forming member is parallel to a vertical direction, the positive electrode is arranged below the negative electrode in the stacking direction.

(8) A bipolar storage battery including:
a plurality of cell members stacked with spacing, each of the cell members including a positive electrode including a positive electrode current collector and a positive active material layer, a negative electrode including a negative electrode current collector and a negative active material layer, and a separator interposed between the positive electrode and the negative electrode;
a space forming member forming a plurality of spaces individually housing the plurality of cell members, the space forming member including a substrate covering at least one of the positive electrode side and the negative electrode side of each of the cell members, and a frame surrounding a side face of each of the cell members; and
a through hole communicating with the space housing the cell member, wherein the through hole has an outer opening open on an outer wall face of the space forming member and an inner opening open on an inner wall face of the space forming member, and an opening position of the outer opening is above an opening position of the inner opening when a stacking direction of the cell members and the space forming member is parallel to a vertical direction.

(9) The bipolar storage battery according to any one of (1) to (8), wherein the positive electrode current collector and the negative electrode current collector are made of lead or a lead alloy.

The following is a list of reference signs used in this specification and in the drawings.
100 Bipolar lead-acid storage battery
110 Cell member
111 Positive electrode
112 Negative electrode
111a Positive electrode lead foil
112a Negative electrode lead foil
111b Positive active material layer
112b Negative active material layer
113 Separator
120 Bipolar plate
120a Outer wall face
120b Inner wall face
121 Substrate of bipolar plate
121a Through hole of substrate
122 Frame of bipolar plate
123 Column
130 First end plate
130a Outer wall face
130b Inner wall face
131 Substrate of first end plate
132 Frame of first end plate
133 Column
140 Second end plate
140a Outer wall face
140b Inner wall face
141 Substrate of second end plate
142 Frame of second end plate
143 Column
150 Adhesive
160 Conductor
170 Cover plate
180 Through hole
181 Outer opening
182 Inner opening
183 Through path
184 Wall portion
190 Lid
191 Communication hole
C Cell (space housing cell member)
F1 First flow direction (of electrolyte solution)
F2 Second flow direction (of electrolyte solution)

What is claimed is:

1. A bipolar storage battery, comprising:
a plurality of cell members stacked with spacing, each of the cell members including a positive electrode including a positive electrode current collector and a positive active material layer, a negative electrode including a negative electrode current collector and a negative active material layer, and a separator interposed between the positive electrode and the negative electrode;
a space forming member forming a plurality of spaces individually housing the plurality of cell members, the space forming member including a substrate covering at least one of a positive electrode side or a negative electrode side of each of the cell members, and a frame surrounding a side face of each of the cell members; and
a through hole communicating with at least one space of the plurality of spaces individually housing the plurality of cell members, wherein the through hole has an outer opening open on an outer wall face of the space forming member and an inner opening open on an inner wall face of the space forming member, and a wall portion is provided in at least a part of a through path connecting the outer opening and the inner opening, the wall portion making a first flow direction of an electrolyte solution flowing in from the outer opening different from a second flow direction in which the electrolyte solution flows out from the inner opening into the space.

2. The bipolar storage battery according to claim 1, wherein the outer opening is formed on an outer wall face of the substrate including at least a part of a distance between one face of the substrate on which the positive electrode is provided and an other face of the substrate on which the negative electrode is provided.

3. The bipolar storage battery according to claim 2, wherein the inner opening is formed on the one face or the other face of the substrate.

4. The bipolar storage battery according to claim 1, wherein the inner opening is provided at a position preventing the electrolyte solution from coming into direct contact with the separator when the electrolyte solution is injected into the space.

5. The bipolar storage battery according to claim 1, wherein, when the bipolar storage battery is placed in such a manner that a stacking direction of the cell members and the space forming member is parallel to a vertical direction, an opening position of the outer opening is above an opening position of the inner opening in the stacking direction.

6. The bipolar storage battery according to claim 1, further comprising:
a lid covering a portion of the frame, the portion surrounding one side face of the cell member, wherein the lid has a communication hole communicating with the through hole, and, when the bipolar storage battery is placed in such a manner that a stacking direction of the cell members and the space forming member is parallel to a vertical direction, an opening position of the communication hole is above an opening position of the outer opening of the through hole in the stacking direction.

7. The bipolar storage battery according to claim 1, wherein, when the bipolar storage battery is placed in such a manner that a stacking direction of the cell members and the space forming member is parallel to a vertical direction, the positive electrode is arranged below the negative electrode in the stacking direction.

8. The bipolar storage battery according to claim 1, wherein the positive electrode current collector and the negative electrode current collector are made of lead or a lead alloy.

9. A bipolar storage battery, comprising:
a plurality of cell members stacked with spacing, each of the cell members including a positive electrode including a positive electrode current collector and a positive active material layer, a negative electrode including a negative electrode current collector and a negative active material layer, and a separator interposed between the positive electrode and the negative electrode;
a space forming member forming a plurality of spaces individually housing the plurality of cell members, the space forming member including a substrate covering at least one of a positive electrode side or a negative electrode side of each of the cell members, and a frame surrounding a side face of each of the cell members; and
a through hole communicating with at least one space of the plurality of spaces individually housing the plurality of cell members, wherein the through hole has an outer opening open on an outer wall face of the space forming member and an inner opening open on an inner wall face of the space forming member, and an opening position of the outer opening is above an opening position of the inner opening when a stacking direction of the cell members and the space forming member is parallel to a vertical direction.

10. The bipolar storage battery according to claim 9, wherein the positive electrode current collector and the negative electrode current collector are made of lead or a lead alloy.
